(19) United States
(12) Patent Application Publication
(10) Pub. No.: US 2021/0246296 A1
(43) Pub. Date: Aug. 12, 2021

(54) FILM, METHOD FOR PRODUCING FILM, OPTICAL DEVICE, AND FOLDABLE DEVICE

(71) Applicant: FUJIFILM Corporation, Tokyo (JP)

(72) Inventors: Takafumi HOSOKAWA, Kanagawa (JP); Kenji KANO, Kanagawa (JP)

(73) Assignee: FUJIFILM Corporation, Tokyo (JP)

(21) Appl. No.: 17/235,210

(22) Filed: Apr. 20, 2021

Related U.S. Application Data
(63) Continuation of application No. PCT/JP2019/039010, filed on Oct. 2, 2019.

(30) Foreign Application Priority Data
Oct. 30, 2018 (JP) 2018-204447

(51) Int. Cl. C08L 33/12; C08J 5/18; C08K 3/36

(52) U.S. Cl. CPC C08L 33/12; C08J 5/18; C08K 3/36; C08J 2325/06; C08J 2409/00; C08K 2201/003; C08K 2201/011; C08J 2369/00; C08J 2333/12

(57) ABSTRACT

A film includes a polymer having a weight-average molecular weight equal to or more than Mf₁ represented by the following Formula (1), Mf₁=6.60×10^{(4+Me/11,400)} (1), in which, in the Formula (1), Me represents an entanglement molecular weight of the polymer, in which a glass transition temperature of the polymer is 60° C. or higher, and a content of fine particles having a particle diameter of from 10 nm to 10 μm in the film is 40 parts by mass or less with respect to 100 parts by mass of the polymer.

### CROSS REFERENCE TO RELATED APPLICATION

This is a continuation of International Application No. PCT/JP2019/039010 filed on Oct. 2, 2019, and claims a priority from Japanese Patent Application No. 2018-204447 filed on Oct. 30, 2018, the entire disclosures of which are incorporated herein by reference.

### BACKGROUND OF THE INVENTION

### 1. Field of the Invention

The present invention relates to a film, a method for producing a film, an optical device, and a foldable device.

### 2. Description of the Related Art

In an image display device such as a display device using a cathode ray tube (CRT), a plasma display (PDP), an electroluminescent display (ELD), a vacuum fluorescent display (VFD), a field emission display (FED), and a liquid crystal display (LCD), it is suitable to provide a film on the surface of the display device in order to prevent scratches on the display surface, and the like. In addition, films comprising various functions are used in parts other than the display surface.

In recent years, for example, in smartphones, tablet terminals, and the like, there is an increasing demand for a flexible display, and along with this, there is a strong demand for an optical film which is hard to break even in a case where it is repeatedly bent (having excellent repeated bending resistance).

For example, JP2018-109773A describes a flexible display which comprises a hard coat film comprising a polyimide film and a hard coat layer.

### SUMMARY OF THE INVENTION

However, films that can be used in applications requiring repeated bending resistance, such as a foldable device, have been limited to polymer films made of specific materials, such as the polyimide film of JP2018-109773A, and have thus problems from the viewpoints of availability and cost.

Therefore, there is a demand for a technique for producing a film having excellent repeated bending resistance without a limit in the type of a polymer.

The present invention has been made in consideration of the problem, and an object thereof is to provide a film having excellent repeated bending resistance, regardless of the type of a polymer used as a raw material of the film; a method for producing the film; and an optical device find a foldable device, each comprising the film.

The present inventors have conducted intensive investigations, and as a result, have found that the object can be accomplished by setting the weight-average molecular weight (Mw) of a polymer used in a film to a specific value or more and setting the content of fine particles in the film to a specific amount or less.

That is, the object has been accomplished by the following means.

<1> A film comprising a polymer having a weight-average molecular weight equal to or more than Mf₁ represented by the following Formula (1),

Mf₁=6.60×10^{(4+Me/11,400)} (1)

in the Formula (1), Me represents an entanglement molecular weight of the polymer,

in which a glass transition temperature of the polymer is 60° C. or higher, and

a content of fine particles having a particle diameter of from 10 nm to 10 μm in the film is 40 parts by mass or less with respect to 100 parts by mass of the polymer.

<2> The film as described in <1>,

in which the weight-average molecular weight of the polymer is equal to or more than Mf₂ represented by the following Formula (2),

Mf₂=1.02×10^{(5+Me/11,400)} (2)

in the Formula (2), Me represents an entanglement molecular weight of the polymer.

<3> The film as described in <1> or <2>,

in which the film is used for a foldable device.

<4> The film as described in any one of <1> to <3>,

in which the polymer is an amorphous polymer.

<5> The film as described in any one of <1> to <4>,

in which the polymer is at least one polymer selected from the group consisting of poly(meth)acrylates, polystyrenes, polyvinyl esters, polyvinyl ethers, amorphous polyarylates, polycarbonates, and copolymers thereof.

<6> The film as described in any one of <1> to <5>,

in which the polymer is a polymer having a repeating unit represented by the following General Formula (X).

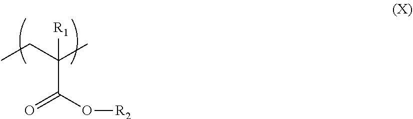

In the General Formula (X), R₁ represents a hydrogen atom or a methyl group, and R₂ represents a hydrogen atom, a substituted or unsubstituted alkyl group, a substituted or unsubstituted cycloalkyl group, or a substituted or unsubstituted aryl group.

<7> The film as described in any one of <1> to <6>,

in which the film has a film thickness of 50 μm or less.

<8> A method for producing a film as described in any one of <1> to <7>, comprising casting a solution containing the polymer and a solvent onto a substrate to form a layer, removing a part or an entirety of the solvent in the layer, and then peeling the layer from which the part or the entirety of the solvent has been removed, from the substrate.

<9> An optical device comprising the film as described in any one of <1> to <7>.

<10> A foldable device comprising the film as described in any one of <1> to <7>.

According to the present invention, it is possible to provide a film having excellent repeated bending resistance, regardless of the type of a polymer used as a raw material of the film; a method for producing the film; and an optical device and a foldable device, each comprising the film.

### DESCRIPTION OF THE PREFERRED EMBODIMENTS

Hereinafter, the contents of the present invention will be described in detail.

In the present specification, a numerical value range expressed using “to” means a range that includes the preceding and succeeding numerical values of “to” as a lower limit value and an upper limit value, respectively.

In the present specification, “(meth)acrylate” is used to mean either or both of acrylate and methacrylate. In addition, a “(meth)acryloyl group” is used to mean either or both of an acryloyl group and a methacryloyl group “(Meth)acryl” is used to mean either or both of acryl and methacryl.

In the present specification, a weight-average molecular weight (Mw) is measured as a standard polymer-equivalent molecular weight by gel permeation chromatography (GPC), and is specifically a weight-average molecular weight measured under the following conditions.

| | |
|---|---|
| Solvent | Tetrahydrofuran |
| Device name | TOSOH HLC-8220 GPC |
| | (manufactured by Tosoh Corporation) |
| Columns | TOSOH TSKgel Super HZM-H |
| | TOSOH TSKgel Super HZ4000 |
| | TOSOH TSKgel Super HZ2000, |

as connected in this order and used (all these columns are manufactured
by Tosoh Corporation).

| | |
|---|---|
| Column temperature | 25° C. |
| Sample concentration | 0.1% by mass |
| Flow rate | 0.35 ml/min |

Calibration curveA standard polymer has a structure close to the structure of a polymer to be measured, and is selected so as to cover the assumed molecular weight range. For example, for poly(meth)acrylates, a calibration curve obtained using 4 samples of Poly(methyl methacrylate) Standard manufactured by SIGMA-ALDRICH with Mp=2,200,000 to 5,050 was used (Mp represents a peak top molecular weight on a GPC chart). For polystyrenes, a calibration curve obtained using 5 samples from Polystyrene Standard manufactured by SIGMA-ALDRICH with Mp=10,300,000 to 1,100 was used. In addition, for polymers having structures other than these, a converted molecular weight was determined using a calibration curve obtained using Polystyrene Standard manufactured by SIGMA-ALDRICH.

[Film]

The film of an embodiment of the present invention includes a polymer having a weight-average molecular weight equal to or more than Mf₁ represented by Formula (1), in which a glass transition temperature of the polymer is 60° C. or higher and a content of fine particles in the film is 40 parts by mass or less with respect to 100 parts by mass of the polymer.

Mf₁=6.60×10^{(4+Me/11,400)} (1)

In Formula (1), Me represents an entanglement molecular weight of the polymer.

<Polymer>

The polymer used in the present invention (hereinafter also referred to as the polymer of the present invention) has a weight-average molecular weight (Mw) equal to or more than Mf₁ represented by the above Formula (1).

First, the entanglement molecular weight of the polymer will be described.

It is known that polymers exist in a state in which the molecular chains are entangled with each other to give a certain molecular weight or more. Generally, this molecular weight is referred to as an entanglement molecular weight (Me). Me is a parameter that characterizes the physical properties of the polymer, and Me values for many polymers are reported in, for example, POLYMER ENGINEERING AND SCIENCE, JUNE 1992, Vol. 32, No. 12 p. 823-830. As the Me value in the present invention, the values according to the document are used.

In addition, with regard to a polymer whose Me value is unknown and a polymer blend system using two or more kinds of polymers, it is also possible to actually measure and determine the Me value, and methods therefor are also described in detail in the document and documents presented in references thereof.

The present inventors have considered that a fact the molecular chains of a polymer material used for a film are entangled with each other, that is, a fact that the polymer chains are easily bent and hard to disentangle contributes to the repeated bending resistance of the film.

Therefore, in order to investigate whether there is a correlation between the entanglement molecular weight (Me) and the weight-average molecular weight (Mw) of the polymer and the repeated bending resistance, various film samples created by changing the polymer structures and the weight-average molecular weights were subjected to a repeated bending resistance test, and thus, a correlation therebetween was found, leading to completion of the present invention.

Formula (1) is expressed as an approximate formula using Me by experimentally determining a minimum weight-average molecular weight at which a film that does not break even in a case where the repeated bending resistance test was carried out more than 600,000 times.

Furthermore, the details of the film samples for deriving Formula (1) and the repeated bending resistance test will be described in Examples which will be described later.

From the viewpoint of improving the repeated bending resistance, it is preferable that the weight-average molecular weight of the polymer of the present invention is equal to or more than Mf₂ represented by Formula (2). Also in Formula (2), Me represents an entanglement molecular weight of the polymer.

Mf₂=1.02×10^{(5+Me/11,400)} (2).

Formula (2) is expressed as an approximate formula using Me by experimentally determining a minimum weight-average molecular weight at which a film that does not break even in a case where the same repeated bending resistance test as in the derivation of Formula (1) was carried out more than 1,000,000 times.

It is preferable that the polymer of the present invention is an amorphous polymer from the viewpoint of transparency.

Above all, at least one kind of polymer selected from the group consisting of poly(meth)acrylates, polystyrenes, polyvinyl esters, polyvinyl ethers, amorphous polyarylates, polycarbonates, and copolymers thereof is more preferable.

—Poly(meth)acrylates—

The poly(meth)acrylates represent a group of polymers in which polyacrylates and polymethacrylates are combined. The poly(meth)acrylates are obtained by polymerizing (meth)acrylates. Above all, a polymer having a repeating unit represented by General Formula (X) is preferable.

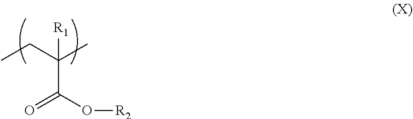

In General Formula (X), R₁ represents a hydrogen atom or a methyl group, and R₂ represents a hydrogen atom, a substituted or unsubstituted alkyl group, a substituted or unsubstituted cycloalkyl group, or a substituted or unsubstituted aryl group.

In a case where R₂ represents an alkyl group, R₂ is preferably an alkyl group having 1 to 10 carbon atoms, and examples thereof include a methyl group, an ethyl group, an n-propyl group, an iso-propyl group, an iso-butyl group, and a tert-butyl group.

In a case where R₂ represents an alkyl group, the alkyl group may have a substituent and the substituent is not particularly limited. Examples of the substituent include an aryl group, a cycloalkyl group, a halogen atom, a hydroxyl group, a carboxy group, a cyano group, an amino group, and a nitro group. Examples of the substituted alkyl group include a benzyl group.

In a case where R₂ represents a cycloalkyl group, R₂ is preferably a cycloalkyl group having 5 to 20 carbon atoms, and examples thereof include a cyclohexyl group, an isobornyl group, and an adamantyl group.

In a case where R₂ represents a cycloalkyl group, the cycloalkyl group may have a substituent, and the substituent is not particularly limited. Examples of the substituent include an aryl group, an alkyl group, a halogen atom, a hydroxyl group, a carboxy group, a cyano group, an amino group, and a nitro group.

In a case where R₂ represents an aryl group, R₂ is preferably an aryl group having 6 to 20 carbon atoms, and examples thereof include a phenyl group and a naphthyl group.

In a case where R₂ represents an aryl group, the aryl group may have a substituent, and the substituent is not particularly limited. Examples of the substituent include an alkyl group, a cycloalkyl group, a halogen atom, a hydroxyl group, a carboxy group, a cyano group, an amino group, and a nitro group.

R₂ is preferably an unsubstituted alkyl group having 1 to 10 carbon atoms, and more preferably a methyl group.

R₁ represents a hydrogen atom or a methyl group, and is preferably the methyl group.

The poly(meth)acrylates may also include a repeating unit derived from a copolymerizable monomer other than (meth)acrylate. Examples of such the monomer include α,β-unsaturated acids such as acrylic acid and methacrylic acid, unsaturated group-containing divalent carboxylic acids such as maleic acid, fumaric acid, and itaconic acid, aromatic vinyl compounds such as styrene and α-methylstyrene, α,β-unsaturated nitriles such as acrylonitrile and methacrylonitrile, maleic anhydride, maleimide, N-substituted maleimide, and glutaric anhydride.

Only one kind of repeating unit derived from the monomers may be introduced into the poly(meth)acrylates, or a combination of two or more kinds of such repeating units may be introduced into the poly(meth)acrylates.

As the poly(meth)acrylates, polymethyl methacrylate (PMMA) is particularly preferable.

Me of PMMA is 9,200, and in a case where the polymer of the present invention is PMMA, a weight-average molecular weight thereof is 423,215 (Mf₁) or more, preferably 654,060 (Mf₂) or more, and more preferably 700,000 or more. In addition, from the viewpoint of synthesis, the weight-average molecular weight is preferably 10,000,000 or less, and more preferably 5,000,000 or less.

—Polystyrenes—

The polystyrenes represent a group of polymers obtained by polymerizing substituted or unsubstituted styrenes. Examples thereof include polystyrene, poly(α-methylstyrene), poly(4-t-butylstyrene), poly(4-chloromethylstyrene), poly(paramethylstyrene), and poly(chloromethylstyrene). In addition, the polystyrenes may be a copolymer of styrenes and another copolymerizable monomer such as an acrylonitrile-styrene copolymer (AS resin). Among these, polystyrene and poly(α-methylstyrene) are preferable.

Me of the polystyrene is 18,700, and in a case where the polymer of the present invention is polystyrene, a weight-average molecular weight thereof is 2,883,333 (Mf₁) or more, preferably 4,456,060 (Mf₂) or more, and more preferably 4,500,000 or more. In addition, from the viewpoint of synthesis, the weight-average molecular weight is preferably 10,000,000 or less, and more preferably 7,000,000 or less.

—Polyvinyl Esters—

The polyvinyl esters represent a group of polymers obtained by polymerizing vinyl esters, and derivatives thereof. Examples thereof include polyvinyl acetate, polyvinyl alcohol, and polyvinyl acetals.

—Polyvinyl Ethers—

The polyvinyl ethers represent a group of polymers having a structure obtained by polymerizing vinyl ethers. Examples thereof include poly(methyl vinyl ether) and poly(ethyl vinyl ether).

—Amorphous Polyarylates—

The amorphous polyarylates represent a group consisting of amorphous polyesters among all aromatic polyesters in which an aromatic dicarboxylic acid and a dihydric phenol are ester-bonded and which are amorphous, and do not include a so-called liquid crystal polymer (LCP).

The aromatic dicarboxylic acid is not particularly limited, but for example, terephthalic acid, isophthalic acid, or 2,6-naphthalenedicarboxylic acid is preferable.

The dihydric phenol is not particularly limited, but for example, diphenylmethane derivatives (also referred to as a bisphenol A) such as bisphenol A are preferable, and bisphenol A (2,2-bis(4-hydroxyphenyl)propane), bisphenol AP (1,1-bis(4-hydroxyphenyl)-1-phenylethane), bisphenol AF (1,1-bis(4-hydroxyphenyl)-1-phenylethane), bisphenol BP (bis(4-hydroxyphenyl)diphenylmethane), bisphenol C (2,2-bis(3-methyl-4-hydroxyphenyl)propane), bisphenol PH (5,5′-methylethylidene)-bis[1,1′-(bisphenyl)-2-ol]propane), bisphenol Z (1,1-bis(4-hydroxyphenyl)cyclohexane) and the like are particularly preferable.

It is known that the amorphous polyarylate is formed with an ester structure of bisphenol A, and terephthalic acid and isophthalic acid (containing equal amounts of terephthalic acid and isophthalic acid) as a repeating unit. An Me value thereof is 1,920, and in a case where the polymer of the present invention is polyarylate, a weight-average molecular weight thereof is 97,267 (Mf₁) or more, preferably 150,322 (Mf₂) or more, and more preferably 160,000 or more. In addition, from the viewpoint of synthesis, the weight-average molecular weight is preferably 1,000,000 or less, and more preferably 500,000 or less.

—Polycarbonates—

The polycarbonates represent a group of polymers having a carbonic ester structure of a bisphenol A. Preferred examples of the bisphenol A can also include those described in the section of the amorphous polyarylates.

The most common polycarbonate is formed of a carbonic ester of a bisphenol A as a repeating unit, and an Me value there is 1,780. In a case where the polymer of the present invention is the polycarbonate, a weight-average molecular weight thereof is 94,555 (Mf₁) or more, preferably 146,130 (Mf₂) or more, and more preferably 150,000 or more. In addition, from the viewpoint of synthesis, the weight-average molecular weight is preferably 1,000,000 or less, and more preferably 500,000 or less.

The polymer of the present invention may be a homopolymer of the monomers exemplified above or a copolymer with copolymerizable monomers. In a case where the polymer of the present invention is a copolymer, it may be either a linear random copolymer or a block copolymer. In addition, it may be a linear polymer, or may be branched or cyclic.

In the present invention, only one kind of the polymers may be used, or two or more kinds of the polymers may be blended and used.

As the polymer of the present invention, poly(meth)acrylates, polystyrenes, amorphous polyarylates, or polycarbonates are preferable, and the poly(meth)acrylates are more preferable.

(Method for Synthesizing Polymer)

A method for obtaining the polymer of the present invention, that is, a high-molecular-weight product having a weight-average molecular weight equal to or more than Mf₁ will be described. As the polymerization method for the polymer of the present invention, any of known polymerization methods can be applied.

Examples of the polymerization method of vinyl monomers to obtain a vinyl polymer that is referred to poly(meth)acrylates, polystyrenes, polyvinyl esters, and polyvinyl ethers include anionic polymerization, cationic polymerization, radical polymerization, and coordination polymerization, and the method can be appropriately selected based on the structures of the monomers. In addition, a solvent may or may not be used in the polymerization step (bulk polymerization). In a case where the solvent is used, emulsion polymerization, suspension polymerization, or precipitation polymerization is preferable.

Examples of a method for obtaining amorphous polyarylates include the method described in “Shin Kobunshi Jikken Gaku (New Polymer Experiments) 3 Kobunshi No Gosei Hanno (Synthesis and Reactions of Polymers) (2)”, pp. 78-95, Kyoritsu Shuppan Co., Ltd. (1996), and specifically include an acid halide method, a transesterification method, a direct esterification method, and an interfacial polymerization method, with the interfacial polymerization method being preferable. In addition, as described in Journal of Japan Oil Chemists' Society, Vol. 46, No. 11 (1997), a method in which a prepolymer having a constant molecular weight is obtained and then subjected to a chain extension reaction to extend the molecular weight can also be preferably used.

Examples of a method for obtaining polycarbonates include a method for obtaining a polycarbonate by reacting a bisphenol A with phosgene (phosgene method), and a method for reacting a bisphenol A with diphenyl carbonate at a high temperature and a reduced pressure to perform fusion while removing phenol (transesterification method).

(Glass Transition Temperature (Tg))

A Tg of the polymer of the present invention is 60° C. or higher, preferably 80° C. or higher, and particularly preferably 100° C. or higher. The upper limit of Tg is not particularly limited, but is generally 300° C. or lower. Within such a range, the film of the embodiment of the present invention can be stably used in a case where it is used as a film used in various foldable devices.

In the present invention, Tg was measured using a differential scanning calorimeter (DSC6200, manufactured by SII Nano Technology Inc.) under the following conditions. The measurement is carried out twice using the same sample, and the measurement results at the time of the second temperature elevation are adopted.
Atmosphere in measurement chamber: Nitrogen (50 mL/min)
Temperature elevating rate: 10° C./min
Measurement start temperature: 0° C.
Measurement end temperature: 200° C.
Specimen pan: Aluminum pan
Mass of measurement specimen: 5 mg
Calculation of Tg: A middle temperature between a declination-start point and a declination-end point in a differential scanning calorimetry (DSC) chart is taken as Tg.

<Fine Particles>

The film of the embodiment of the present invention may or may not contain fine particles.

For example, in a case where it is desired to impart higher scratch resistance, it is preferable to add hard fine particles. Examples of such fine particles include inorganic fine particles such as diamond powder, sapphire particles, boron carbide particles, silicon carbide particles, alumina particles, zirconia particles, titania particles, antimony trioxide particles, and silica particles (commercially available products thereof include SNOWTEX UP and MEK-ST-40, manufactured by Nissan Chemical Corporation), calcium carbonate, magnesium carbonate, calcium oxide, zinc oxide, magnesium oxide, sodium silicate, iron oxide, barium sulfate, tin oxide, antimony trioxide, and molybdenum disulfide; or acrylic crosslinked polymers, and styrene crosslinked polymers.

In addition, in a case where it is desired to, for example, impart higher repeated bending resistance, improve brittleness, and improve handleability, it is preferable to add rubber elastic particles. As the rubber elastic particles, commercially available rubber elastic particles can also be used, examples thereof include METABLEN W-341 (C2) manufactured by Mitsubishi Rayon Co., Ltd., “KANEACE” manufactured by Kaneka Corporation, “PARALOID” manufactured by Kureha Chemical Industry Co., Ltd., “ACRYLOID” manufactured by Rohm and Haas Co., “STAFILOID” manufactured by Ganz Chemical Industry Co., and “PARAPET SA” manufactured by Kuraray Co., Ltd., and these may be used alone or in combination of two or more kinds thereof.

The particle diameter of the fine particles that are preferably used in the present invention is not particularly limited, but is preferably from 10 nm to 10 μm, more preferably from 20 nm to 1 μm, and particularly most preferably from 50 nm to 400 nm.

It should be noted that a content of fine particles having a particle diameter of from 10 nm to 10 μm in the film of the embodiment of the present invention is 40 parts by mass or less, preferably 20 parts by mass or less, and more preferably 15 parts by mass or less with respect to 100 parts by mass of the polymer in the film. By setting the content of the fine particles within the range, various characteristics (for example, scratch resistance and transparency), particularly required for a film for a foldable device, can be imparted, in addition to the repeated bending resistance of a film thus obtained.

Furthermore, the film of the embodiment of the present invention may or may not contain particles having a particle diameter of more than 10 μm, but from the same viewpoint as above, in a case where the particles are contained, the polymers are contained in the amount of preferably 40 parts by mass or less, more preferably 20 parts by mass or less, and still more preferably 15 parts by mass or less with respect to 100 parts by mass of the film.

<Method for Producing Film>

The film of the embodiment of the present invention is preferably produced by a solution film forming method.

That is, specifically, the method for producing a film of an embodiment of the present invention is preferably a method for producing a film, including a step of casting a solution (dope composition) containing the polymer and a solvent on a substrate to form a layer, removing a part or an entirety of the solvent in the layer, and then peeling the layer (cast film) from which the part or the entirety of the solvent has been removed, from the substrate.

(Dope Composition)

The dope composition is a composition including at least the polymer of the present invention and a solvent, and includes the fine particles, as necessary.

A content of the polymer in the dope composition is preferably 1% to 50% by mass, more preferably 3% to 40% by mass, and still more preferably 5% to 35% by mass.

—Solvent—

An organic solvent is preferable as the solvent included in the dope composition.

The organic solvent can be used without limitation as long as it dissolves the polymer and additives to be added, as necessary.

Examples of a chlorine-based organic solvent as an example of the organic solvent include methylene chloride (dichloromethane), and examples of a non-chlorine-based organic solvent as another example of the organic solvent include methyl acetate, ethyl acetate, amyl acetate, acetone, methyl ethyl ketone, methyl isobutyl ketone, tetrahydrofuran, 1,3-dioxolane, 1,4-dioxane, cyclohexanone, ethyl formate, 2,2,2-trifluoroethanol, 2,2,3,3-hexafluoro-1-propanol, 1,3-difluoro-2-propanol, 1,1,1,3,3,3-hexafluoro-2-methyl-2-propanol, 1,1,1,3,3,3-hexafluoro-2-propanol, 2,2,3,3,3-pentafluoro-1-propanol, and nitroethane, among which methylene chloride, methyl acetate, ethyl acetate, acetone, or methyl ethyl ketone can be preferably used.

In addition to the organic solvents, the dope composition may also contain 1% to 40% by mass of a linear or branched aliphatic alcohol having 1 to 4 carbon atoms. In a case where a ratio of the alcohol in the dope composition is increased, a cast film can be easily peeled off (peeled) from a substrate (metal support), and in a case where the ratio of the alcohol is low, it can also play a role in promoting dissolution of the polymer in a non-chlorine-based organic solvent system.

In the present invention, in a case where a plurality of solvents are used, a solvent having the highest weight ratio therein may be referred to as a main solvent.

Examples of the linear or branched aliphatic alcohol basing 1 to 4 carbon atoms include methanol, ethanol, n-propanol, isopropanol, n-butanol, s-butanol, and t-butanol. Among these, methanol is particularly preferable due to the stability, a relatively low boiling point, and a good drying property of the dope composition.

—Additives—

Additives other than the fine particles may be added to the dope composition as long as the effects according to the present invention are not impaired.

As the additive, a plasticizer, an ultraviolet absorber, an antioxidant, a brittleness improver, an optical expression agent, or the like can be added.

The plasticizer has a function of improving the fluidity and the flexibility of a dope composition to be used in the production of an optical film. Examples of the plasticizer include phthalic ester-based plasticizers, fatty acid ester-based plasticizers, trimellitic ester-based plasticizers, phosphoric ester-based plasticizers, polyester-based plasticizers, and epoxy-based plasticizers.

Examples of the ultraviolet absorber include benzotriazole-based ultraviolet absorbers, 2-hydroxybenzophenone-based ultraviolet absorber, and salicylic acid phenyl ester-based ultraviolet absorbers. For example, triazoles such as 2-(5-methyl-2-hydroxyphenyl)benzotriazole, 2-[2-hydroxy-3,5-bis(α,α-dimethylbenzyl)phenyl]-2H-benzotriazole, and 2-(3,5-di-t-butyl-2-hydroxyphenyl)benzotriazole, or benzophenones such as 2-hydroxy-4-methoxybenzophenone, 2-hydroxy-4-octoxybenzophenone, 2,2′-dihydroxy-4-methoxybenzophenone are preferable.

In addition, various antioxidants, brittleness improvers, optical expression agents, rubber elastic particles, or the like can be added as additives in order to improve thermal decomposability and thermal colorability at the time of molding processing.

Details of a solution film forming process, such as casting of the dope composition onto a substrate, removal of a solvent, and peeling of a cast film are described in detail in, for example, paragraphs [0045] to [0056] of JP2016-043494A.

<Functional Layer>

The film of the embodiment of the present invention may have a functional layer laminated on at least one surface.

The functional layer is not particularly limited, and examples thereof include a hard coat layer (HC layer), a low-refractive-index layer, a high-refractive-index layer, an abrasion resistant layer, a low-reflectance layer, an antifouling layer, and an inorganic oxide layer (anti-reflection layer), a barrier layer, and a combination thereof.

In a case where the film of the embodiment of the present invention is used as a surface protective film for an image display device, it is preferable to have an HC layer as a functional layer from the viewpoint of improving the scratch resistance.

In a case where the functional layer is an HC layer, the HC layer that is used in the present invention can be obtained by curing a curable composition for forming an HC layer by irradiating the composition with active energy rays. Further, in the present specification, the “active energy rays” mean ionizing radiation, and examples thereof include X-rays, ultraviolet rays, visible light, infrared rays, electron beams, α-rays, β-rays, and γ-rays.

<Film Thickness>

The film thickness of the film of the embodiment of the present invention is not particularly limited, and is often 5 μm or more, and preferably 10 μm or more in view of film strength and handleability. An upper limit thereof is not particularly limited, but is preferably 100 μm or less, more preferably 50 μm or less, and still more preferably 45 μm or less from the viewpoint that more excellent repeated bending resistance can be imparted and the film thickness is advantageous for reducing the thickness of a device.

The film thickness of the film is an average value, which is a value obtained by measuring the film thickness of any 10 or more points of the film and arithmetically averaging the obtained measured values.

Furthermore, in a case where the film of the embodiment of the present invention has a functional layer, the film thickness of the entire film including the functional layer is preferably within the range.

<Repeated Bending Resistance>

The film of the embodiment of the present invention has excellent repeated bending resistance. Specifically, in a case where a repeated bending test at a radius of curvature of 2 mm was carried out with a small desktop planar load-free U-shaped expansion and contraction tester (model: DLDMLH-FS, manufactured by Yuasa Sy stem Co., Ltd.), the number of times of the bending until breakage of the film occurs is preferably more than 600,000 times, more preferably more than 800,000 times, and still more preferably more than 1,000,000 times.

<Scratch Resistance>

In a case where the film of the embodiment of the present invention is, for example, used as the outermost layer of a device which will be described later, it is preferable that the film of the embodiment of the present invention has excellent scratch resistance. A pencil hardness (JIS K5600-5-4 (1999)) is known as an index of the scratch resistance. The pencil hardness of the film of the embodiment of the present invention is preferably B or higher, and particularly preferably H or higher.

The film of the embodiment of the present invention can be applied to various applications such as an optical film. Examples of the film of the embodiment of the present invention include a film for a display and a film for a flexible substrate, and the film for a display is particularly preferable.

Furthermore, in a case where the film of the embodiment of the present invention is used as the film for a display, the film of the embodiment of the present invention may be used as the outermost layer or the film of the embodiment of the present invention may also be used as a layer (for example, an inner film) other than the outermost layer. In a case where the film of the embodiment of the present invention is used as the outermost layer, it can be used as, for example, a substitute for glass that is used as a surface protective layer of a smart device (for example, a smartphone and a tablet).

The film of the embodiment of the present invention is preferably used for a foldable device (foldable display). The foldable device is a device that employs a flexible display whose display screen can be deformed, and a device body (display) thereof can be folded by utilizing the deformability of the display screen.

Examples of the foldable device include an organic electroluminescent device.

[Optical Device and Foldable Device]

The present invention also relates to an optical device comprising the film of the embodiment of the present invention and a foldable device comprising the film of the embodiment of the present invention.

### EXAMPLES

Hereinafter, the present invention will be described in more detail with reference to Examples. Further, it should be noted that the present invention is not construed as being limited thereto. “Parts” and “%” that express the composition in the following Examples are based on mass unless otherwise specified.

### Synthesis Example 1

### Synthesis of Polymethyl Methacrylate (Polymer 1)

300 g of ion exchange water and 0.72 g of sodium polyacrylate (A-20P manufactured by Toagosei Co., Ltd.) were added to a 1 L-capacity three-necked flask equipped with a stirrer, a thermometer, and a recirculation pipe, and stirred to completely dissolve the sodium polyacrylate, then 100 g of methyl methacrylate and 0.04 g of dimethyl 2,2′-azobis(isobutyrate) were added thereto, and the mixture was reacted at 85° C. for 6 hours. A suspension thus obtained was filtered through a nylon-made filter cloth and washed with methanol, and the filtered product was vacuum-dried at 50° C. to obtain a desired bead-shaped polymer (Polymer 1).

Polymer 5 and Comparative Polymer 1 were synthesized by the same method as in Synthesis Example 1, except that the amount ratios of the monomer and the initiator each used were adjusted.

Polystyrene (Polymer 2, Polymer 6, and Comparative Polymer 2) was obtained by the same method as in Synthesis Example 1, except that styrene was used as the monomer instead of methyl methacrylate and the amount ratios of the monomer and the initiator were adjusted.

### Synthesis Example 2

### Synthesis of Polymer 3 (PAR)

Ion exchange water (407 g), sodium hydroxide (4.2 g), tributylbenzylammonium chloride (0.26 g), sodium thiosulfate (0.05 g), and bisphenol A (9.59 g) were added into a 1 L-capacity three-necked flask equipped with a stirrer, a nitrogen introduction pipe, a thermometer, a recirculation pipe, and a dropping device, and the mixture was stirred at room temperature in a nitrogen stream. Methylene chloride (153 g) was added to a suspension thus obtained, and a solution obtained by dissolving terephthalic acid chloride (4.26 g) and isophthalic acid chloride (4.26 g) in methylene chloride (50 g) was added dropwise thereto over 30 minutes while maintaining the temperature of the reaction solution at 15° C., and the reaction was continued for additional 1 hour. After neutralizing the aqueous layer of the reaction solution with acetic acid, the recovered organic layer was diluted with methylene chloride (100 g) and washed with ion exchange water (400 g). An operation in which the organic layer is collected, diluted with methylene chloride (100 g), and washed with ion exchange water (400 g) was further carried out twice, the obtained organic layer was reprecipitated in a large excess amount of methanol, and a powdery polymer thus obtained was vacuum-dried at 50° C. to obtain a desired polymer (Polymer 3).

Polymer 7 and Comparative Polymer 3 were synthesized by the same method as in Synthesis Example 2, except that the amount ratio of the monomers was adjusted.

### Synthesis Example 3

### Synthesis of Polymer 4 (PC)

A bisphenol A (100.0 g), diphenyl carbonate (94.0 g), and N,N-dimethyl-4-aminopyridine (7 mg) were charged into a 500 mL-capacity separable flask equipped with a depressurizer, a stirrer, a nitrogen introduction pipe, a thermometer, and a recirculation pipe, the temperature inside the reaction vessel was elevated to 120° C. while stirring the mixture in a nitrogen stream, and the system was held at the same temperature for 10 minutes. Next, the temperature inside the reaction vessel was elevated to 160° C., the same temperature was held for 10 minutes, then the temperature inside the reaction vessel was elevated to 180° C., the nitrogen stream was stopped, and the pressure inside the reaction vessel was reduced to 10 Torr. The reaction was continued for 40 minutes while evaporating phenol thus generated, the temperature inside the reaction vessel was elevated to 200° C., and the system was held at the temperature for 30 minutes. Then, the temperature inside the glass vessel was elevated to 240° C., then the reaction was continued at the same temperature for 1 hour, the pressure inside the reaction vessel was reduced to 0.1 Torr, and the reaction was continued for additional 6 hours. After completion of the reaction, a nitrogen gas was added to the reaction vessel, the pressure was returned to normal pressure, and the mixture was cooled to room temperature. Polycarbonate thus obtained was dissolved in chloroform and reprecipitated twice with a large excess of methanol, and a powdery polymer thus obtained was vacuum-dried at 50° C. to obtain a desired polymer (Polymer 4).

1 Torr is about 133.322 Pa.

Polymer 8 and Comparative Polymer 4 were synthesized by the same method as in Synthesis Example 3, except that the amount ratio of the monomers was adjusted.

In Table 1 below, the structures, Me, Mf₁, Mf₂, Mw, and Tg of the polymers used in Examples and Comparative Examples of the present invention are summarized. Mw and Tg were measured by the above-mentioned method. Mf₁ and Mf₂ are values calculated from Formulae (1) and (2).

TABLE 1

| | Structure | Me | Mf₁ | Mf₂ | Mw | Tg |
|---|---|---|---|---|---|---|
| Polymer 1 | PMMA | 9,200 | 423,215 | 654,060 | 700,000 | 118° C. |
| Polymer 2 | PSt | 18,700 | 2,883,333 | 4,456,060 | 4,500,000 | 115° C. |
| Polymer 3 | PAR | 1,920 | 97,267 | 150,322 | 169,000 | 195° C. |
| Polymer 4 | PC | 1,780 | 94,555 | 146,130 | 150,000 | 160° C. |
| Polymer 5 | PMMA | 9,200 | 423,215 | 654,060 | 510,000 | 115° C. |
| Polymer 6 | PSt | 18,700 | 2,883,333 | 4,456,060 | 3,650,000 | 110° C. |
| Polymer 7 | PAR | 1,920 | 97,267 | 150,322 | 100,000 | 195° C. |
| Polymer 8 | PC | 1,780 | 94,555 | 146,130 | 95,000 | 158° C. |
| Comparative Polymer 1 | PMMA | 9,200 | 423,215 | 654,060 | 380,000 | 101° C. |
| Comparative Polymer 2 | PSt | 18,700 | 2,883,333 | 4,456,060 | 2,000,00 | 100° C. |
| Comparative Polymer 3 | PAR | 1,920 | 97,267 | 150,322 | 65,000 | 193° C. |
| Comparative Polymer 4 | PC | 1,780 | 94,555 | 146,130 | 68,000 | 150° C. |

The respective abbreviations in Table 1 above indicate the following contents.
PMMA: Polymethyl methacrylate
PSt: Polystyrene
PAR: Polycondensate of bisphenol A and terephthalic acid/isophthalic acid (containing terephthalic acid and isophthalic acid in equal amounts)
PC: Polycarbonate

### Example 1

(Preparation of Dope Composition 1)

Polymer 1 (381 mg) was dissolved in dichloromethane (6.0 g) and filtered through a membrane filter having a pore diameter of 1 μm to obtain a dope composition 1.

(Manufacture of Film 1)

The obtained dope composition 1 was cast on a petri dish having an inner diameter of 117 mm and gradually dried at room temperature in a dichloromethane atmosphere. Then, a laser obtained by drying the resultant under reduced pressure at room temperature, followed by peeling from a bottom surface of the petri dish, was dried by heating at 120° C. for 5 minutes to completely remove dichloromethane to obtain a film 1. The film thickness of the film 1 was 30 μm.

### Examples 2 to 8 and Comparative Examples 1 to 4

Films 2 to 8 and Comparative Films 1 to 4 were manufactured in the same manner as in Example 1, except that the types of the polymers used for manufacturing a film were changed to polymers shown in Table 2.

### Examples 9 to 11

Films 9 to 11 were manufactured in the same manner as in Example 1, except that the film thickness was changed to the film thickness shown in Table 2.

<Evaluation>

The films obtained in Examples and Comparative Examples above were evaluated as follows. The results are shown in Table 2.

(Repeated Bending Resistance)

Using the films obtained in Examples and Comparative Examples, a repeated bending test at a radius of curvature of 2 mm was carried out with a small desktop planar load-free U-shaped expansion and contraction tester (model: DLDMLH-FS, manufactured by Yuasa System Co., Ltd.), the number of times of the bending until breakage of the film occurred was measured and evaluated using the following standard.

A: The film was not broken even after the bending was performed more than 1,000,000 times.

B: The film was broken more than 800,000 times and 1,000,000 times or less.

C: The film was broken more than 600,000 times and 800,000 times or less.

D: The film was broken 600,000 times or less.

TABLE 2

| | | | | Evaluation |
|---|---|---|---|---|
| | | Type of | Film | Repeated bending |
| | Film | polymer | thickness | resistance |
| Example 1 | Film 1 | Polymer 1 | 30 μm | A |
| Example 2 | Film 2 | Polymer 2 | 30 μm | A |
| Example 3 | Film 3 | Polymer 3 | 30 μm | A |
| Example 4 | Film 4 | Polymer 4 | 30 μm | A |
| Example 5 | Film 5 | Polymer 5 | 30 μm | B |
| Example 6 | Film 6 | Polymer 6 | 30 μm | B |
| Example 7 | Film 7 | Polymer 7 | 30 μm | B |
| Example 8 | Film 8 | Polymer 8 | 30 μm | B |
| Example 9 | Film 9 | Polymer 1 | 60 μm | C |
| Example 10 | Film 10 | Polymer 1 | 50 μm | B |
| Example 11 | Film 11 | Polymer 1 | 40 μm | A |
| Comparative | Comparative | Comparative | 30 μm | D |
| Example 1 | Film 1 | Polymer 1 | | |
| Comparative | Comparative | Comparative | 30 μm | D |
| Example 2 | Film 2 | Polymer 2 | | |
| Comparative | Comparative | Comparative | 30 μm | D |
| Example 3 | Film 3 | Polymer 3 | | |
| Comparative | Comparative | Comparative | 30 μm | D |
| Example 4 | Film 4 | Polymer 4 | | |

From the above, it was found that the films of Examples had better repeated bending resistance than the films of Comparative Examples.

### Examples 12 to 17 and Comparative Examples 5 and 6

Films 12 to 17 and Comparative Films 5 and 6 were manufactured in the same manner as in Example 1, except that the fine particles described in Table 3 were added to the dope composition 1 in the addition amounts shown in Table 3. Further, the addition amount of the fine particles in Table 3 is in parts by mass with respect to 100 parts by mass of Polymer 1.

With regard to the manufactured film, evaluations of the repeated bending resistance and the following scratch resistance (pencil hardness) were performed. The results are shown in Table 3 together with the results of Example 1.

(Pencil Hardness)

Using the films obtained in Examples and Comparative Examples, the pencil hardness was measured in accordance with the method specified in JIS K5600-5-4 (1999) (load: 200 g weight). The test was repeated five times, and a pencil hardness at which the number of limes with no scratch mark was 3 or more was adopted and evaluated using the following standard.

A: The pencil hardness is H or higher.

B: The pencil hardness is B to F.

C: The pencil hardness is 2B or less.

TABLE 3

| | | | | | | Evaluation | |
|---|---|---|---|---|---|---|---|
| | | | Fine particles | | | Repeated | |
| | | Type of | | Addition | Film | bending | Pencil |
| | Film | polymer | Type | amount | thickness | resistance | hardness |
| Example 1 | Film 1 | Polymer 1 | — | 0 parts by mass | 30 μm | A | A |
| Example 12 | Film 12 | Polymer 1 | M-210 | 10 parts by mass | 30 μm | A | A |
| Example 13 | Film 13 | Polymer 1 | M-210 | 20 parts by mass | 30 μm | A | A |
| Example 14 | Film 14 | Polymer 1 | M-210 | 40 parts by mass | 30 μm | A | B |
| Example 15 | Film 15 | Polymer 1 | MEK-ST | 10 parts by mass | 30 μm | A | A |
| Example 16 | Film 16 | Polymer 1 | MEK-ST | 20 parts by mass | 30 μm | A | A |
| Example 17 | Film 17 | Polymer 1 | MEK-ST | 40 parts by mass | 30 μm | B | A |
| Comparative | Comparative | Polymer 1 | M-210 | 50 parts by mass | 30 μm | A | C |
| Example 5 | Film 5 | | | | | | |
| Comparative | Comparative | Polymer 1 | MEK-ST | 50 parts by mass | 30 μm | D | A |
| Example 6 | Film 6 | | | | | | |

The respective abbreviations in Table 3 indicate the following contents.

M-210: “KANEKA M-210” manufactured by Kaneka Corporation (rubber elastic particles, particle diameter: 220 nm)

MEK-ST: “MEK-ST-40” manufactured by Nissan Chemical Corporation (hard silica particles, particle diameter: 12 nm)

From the above, it was found that the films of Examples had good repeated bending resistance and pencil hardness.

According to the present invention, it is possible to provide a film having excellent repeated bending resistance, regardless of the type of a polymer used as a raw material of the film; a method for producing the film; and an optical device and a foldable device, each comprising the film.

Although the present invention has been described in detail with reference to specific embodiments, it will be apparent to those skilled in the art that various changes and modifications can be made without departing from the spirit and the scope of the present invention.

What is claimed is:

1. A film comprising a polymer having a weight-average molecular weight equal to or more than Mf₁ represented by the following Formula (1),
Mf₁=6.60×10^{(4+Me/11,400)} (1)
wherein, in the Formula (1), Me represents an entanglement molecular weight of the polymer,
wherein a glass transition temperature of the polymer is 60° C. or higher, and
a content of fine particles having a particle diameter of from 10 nm to 10 μm in the film is 40 parts by mass or less with respect to 100 parts by mass of the polymer.

2. The film according to claim 1,
wherein the weight-average molecular weight of the polymer is equal to or more than Mf₂ represented by the following Formula (2),
Mf₂=1.02×10^{(5+Me/11,400)} (2)
wherein, in the Formula (2), Me represents an entanglement molecular weight of the polymer.

3. The film according to claim 1,
wherein the film is used for a foldable device.

4. The film according to claim 2,
wherein the film is used for a foldable device.

5. The film according to claim 1,
wherein the polymer is an amorphous polymer.

6. The film according to claim 2,
wherein the polymer is an amorphous polymer.

7. The film according to claim 3,
wherein the polymer is an amorphous polymer. cm 8. The film according to claim 4,
wherein the polymer is an amorphous polymer.

9. The film according to claim 1,
wherein the polymer is at least one polymer selected from the group consisting of poly(meth)acrylates, polystyrenes, polyvinyl esters, polyvinyl ethers, amorphous polyarylates, polycarbonates, and copolymers thereof.

10. The film according to claim 2,
wherein the polymer is at least one polymer selected from the group consisting of poly(meth)acrylates, polystyrenes, polyvinyl esters, polyvinyl ethers, amorphous polyarylates, polycarbonates, and copolymers thereof.

11. The film according to claim 3,
wherein the polymer is at least one polymer selected from the group consisting of poly(meth)acrylates, polystyrenes, polyvinyl esters, polyvinyl ethers, amorphous polyarylates, polycarbonates, and copolymers thereof.

12. The film according to claim 4,
wherein the polymer is at least one polymer selected from the group consisting of poly(meth)acrylates, polystyrenes, polyvinyl esters, polyvinyl ethers, amorphous polyarylates, polycarbonates, and copolymers thereof.

13. The film according to claim 1,
wherein the polymer is a polymer having a repeating unit represented by the following General Formula (X), 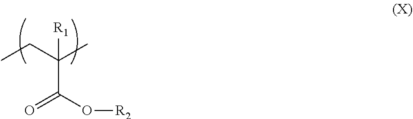
wherein, in the General Formula (X), R₁ represents a hydrogen atom or a methyl group, and R₂ represents a hydrogen atom, a substituted or unsubstituted alkyl group, a substituted or unsubstituted cycloalkyl group, or a substituted or unsubstituted aryl group.

14. The film according to claim 2,
wherein the polymer is a polymer having a repealing unit represented by the following General Formula (X), 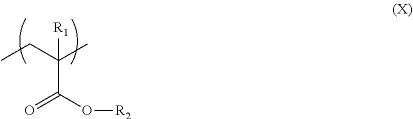
wherein, in the General Formula (X), R₁ represents a hydrogen atom or a methyl group, and R₂ represents a hydrogen atom, a substituted or unsubstituted alkyl group, a substituted or unsubstituted cycloalkyl group, or a substituted or unsubstituted aryl group.

15. The film according to claim 3,
wherein the polymer is a polymer having a repeating unit represented by the following General Formula (X), 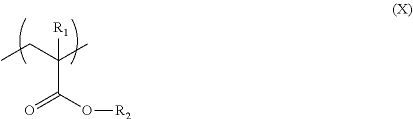
wherein, in the General Formula (X), R₁ represents a hydrogen atom or a methyl group, and R₂ represents a hydrogen atom, a substituted or unsubstituted alkyl group, a substituted or unsubstituted cycloalkyl group, or a substituted or unsubstituted aryl group.

16. The film according to claim 4,
wherein the polymer is a polymer having a repeating unit represented by the following General Formula (X), 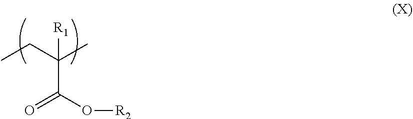
wherein, in the General Formula (X), R₁ represents a hydrogen atom or a methyl group, and R₂ represents a hydrogen atom, a substituted or unsubstituted alkyl group, a substituted or unsubstituted cycloalkyl group, or a substituted or unsubstituted aryl group.

17. The film according to claim 1,
wherein the film has a film thickness of 50 μm or less.

18. A method for producing a film according to claim 1, comprising:
casting a solution containing the polymer and a solvent onto a substrate to form a layer, removing a part or an entirety of the solvent in the layer, and then peeling the layer from which the part or the entirety of the solvent has been removed, from the substrate.

19. An optical device comprising the film according to claim 1.

20. A foldable device comprising the film according to claim 1.
